(19) United States
(12) Patent Application Publication
(10) Pub. No.: US 2012/0217861 A1
(43) Pub. Date: Aug. 30, 2012

(54) LED Heat Sink Assembly

(76) Inventor: Vimal J. Soni, Mumbai (IN)

(21) Appl. No.: 13/034,327

(22) Filed: Feb. 24, 2011

Related U.S. Application Data
(63) Continuation of application No. 13/034,019, filed on Feb. 24, 2011.

(51) Int. Cl. H01J 61/52

(52) U.S. Cl. 313/46

(57) ABSTRACT

An LED light source is provided that is comprised of a heat sink assembly and at least one LED, where the heat sink assembly includes a hollow heat sink (e.g., a cylindrical heat sink) and an LED thermal pad that mechanically closes an opening in the heat sink via direct mechanical and thermal contact. The thermal pad or pads of the LED are in direct mechanical and thermal contact with an upper surface of the LED thermal pad.

### CROSS-REFERENCE TO RELATED APPLICATION

This application is a continuation of U.S. patent application Ser. No. 13/034,019, filed Feb. 24, 2011, the disclosure of which is incorporated herein by reference for any and all purposes.

### FIELD OF THE INVENTION

The present invention relates generally to light sources and, more particularly, to an LED light assembly.

### BACKGROUND OF THE INVENTION

In a world of rapidly increasing energy needs, many countries are trying to find ways to lower energy consumption, especially in light of the environmental concerns associated with conventional energy sources (e.g., greenhouse gas emissions, waste heat, disposal and storage of radioactive waste, etc.). Since approximately 10% of the energy used in a typical household goes towards lighting, and given that about 90% of the power consumed by a standard incandescent light is emitted as heat, rather than light, considerable emphasis has been placed on replacing inefficient incandescent lights with more efficient light sources.

For many applications, residential and commercial alike, fluorescent lighting, and specifically compact fluorescent lights or CFLs, initially appeared to be an ideal replacement light source. Unfortunately, while CFLs do provide increased efficiency, on the order of 2 to 10 times the luminous efficiency of an incandescent source, CFLs are not without their drawbacks. One of the primary drawbacks has been the use of hazardous materials such as mercury within the CFL, leading to concerns during use because of the possibility of unintentional breakage as well as concerns relating to the proper disposal of inoperative CFLs. Other drawbacks include cost, flickering, slow start-up, variations in color temperature, form factor, and incompatibility with some dimming circuits.

In addition to overcoming most, if not all, of the drawbacks associated with CFLs, LEDs offer a number of other advantages. For instance, a typical LED has a life expectancy of at least 10 times that of a CFL, and at least 100 times that of a conventional incandescent light. Additionally, due to the directional nature of the light emitted by an LED, light fixtures that utilize LEDs can often be simplified through the reduction or elimination of reflectors and diffusers. Given these advantages, and given the recent advances in the output efficiency of LEDs, many manufacturers have turned to LEDs as the likely successor to both incandescent and fluorescent lights. Currently, the primary obstacles associated with LED light bulbs have been their high cost, due in part to the extremely complex light assemblies used to date, and the heat generated by the LED assembly.

A number of approaches have been suggested to overcome the heat generated in a typical LED lighting application. For example, U.S. Pat. No. 7,144,135 discloses an LED assembly in which a fan is used to direct air over a heat sink to which the LED is mounted. The assembly includes an exterior shell that includes one or more apertures, the apertures being used as air inlets or exhaust apertures. A somewhat similar assembly is disclosed in U.S. Pat. No. 7,144,140 in which the LED assembly includes a fan that forces air out of the light casing and away from the light fixture.

U.S. Pat. No. 7,497,596 discloses a variety of LED lamp configurations that utilize one or more LEDs. The disclosed design is intended to eliminate the use of glue to couple the metal base of the LED chip to the circuit board, thereby overcoming the possibility of the glue layer splitting over the course of time due to the normal temperature cycling of the chip. In the disclosed assemblies, each LED chip is mounted directly to a metal base that is, in turn, thermodynamically and mechanically coupled to a heat sink utilizing at least one screw. Rather than interposing the LED circuit board between the metal base and the heat sink, the disclosed LED circuit board is mounted to the metal base, for example on top of the metal base, and connected to the individual LEDs via leads.

U.S. Pat. No. 7,524,089 discloses an LED light that utilizes a cooling fan mounted within the main body of the light. The main body includes a plurality of radial partition walls spaced apart from one another, and separated by slit-shaped gaps. The cooling fan forcibly circulates air within the main body and through the slit-shaped gaps, thereby cooling the LEDs. The patent also discloses a lamp base that includes a plurality of apertures that allow air to enter the body for circulation by the fan.

U.S. Pat. No. 7,878,697 discloses an LED light source that utilizes a container filled with liquid to dissipate the heat generated by the LED light source module. As disclosed, the light emitted by the LED lamp passes through the liquid filled container, the liquid being used to spread the light angle. A thermal conductor attached to the LED light source module extends into the liquid to enhance heat dissipation from the module.

U.S. Patent Application No. 2010/0277067 discloses a dimmable LED light source that includes a heat sink disposed between the base and the lighting optic. The LED assembly is in thermal communication with a surface of the heat sink. The heat sink may include radially extending arms or fins to help dissipate the heat generated by the LED assembly.

Although the prior art discloses a number of LED lamp assemblies, in general these assemblies are complex, and therefore potentially time consuming and costly to manufacture. Additionally, many of these assemblies disclose relatively complicated cooling assemblies that may add to the cost of the light while lowering the light's life expectancy. Accordingly, what is needed is an LED light that is easy to manufacture, lends itself to various form factors, and efficiently dissipates the heat generated by the LED assembly. The present invention provides such a light.

### SUMMARY OF THE INVENTION

The present invention provides an LED light source that is comprised of a heat sink assembly and at least one LED, wherein the heat sink assembly is comprised of a cylindrical heat sink and a disc-shaped LED thermal pad that is in direct mechanical and thermal contact with the cylindrical heat sink and mechanically closes an end portion of the cylindrical heat sink, and wherein the thermal pad of the at least one LED is in direct mechanical and thermal contact with an upper surface of the disc-shaped LED thermal pad. The LED light source may further comprise a printed circuit board, where the at least one LED is attached to the printed circuit board and the printed circuit board is attached to the upper surface of the disc-shaped LED thermal pad, wherein the upper surface of the disc-shaped LED thermal pad includes at least one ridge-like structure that extends away from the upper surface and through at least one aperture in the printed circuit board, thereby allowing direct thermal and mechanical contact between the thermal pads of the at least one LED and the disc-shaped LED thermal pad. An outer surface of the cylindrical heat sink may include a plurality of fins. The disc-shaped LED thermal pad and the printed circuit board may each include apertures that allow passage of LED electrical connectors through the apertures to form an electrical connection with a set of LED contact pads. The disc-shaped LED thermal pad may include a plurality of heat transfer vias. The disc-shaped LED thermal pad may further comprise an electrically insulating layer and an electrically conductive contact pattern, where the electrically insulating layer is disposed on a portion of an upper surface of the thermal pad but is not interposed between the thermal pad of the at least one LED and the upper surface of the disc-shaped LED thermal pad, and where the electrically conductive contact pattern is disposed on the electrically insulating layer of material and couples a set of LED electrical contact pads to an LED drive circuit. The disc-shaped LED thermal pad may form an interference fit with an inner surface of the cylindrical heat sink.

In another aspect of the invention, an LED light source is provided that is comprised of a heat sink assembly and at least one LED, wherein the heat sink assembly is comprised of a hollow heat sink and an LED thermal pad shaped to mechanically close an opening in the hollow heat sink via direct mechanical and thermal contact, and wherein the thermal pad of the at least one LED is in direct mechanical and thermal contact with an upper surface of the LED thermal pad. An outer surface of the hollow heat sink may be covered by a plurality of fins. The LED thermal pad may form an interference fit with the opening of the hollow heat sink. The LED light source may further comprise a printed circuit board, where the at least one LED is attached to the printed circuit board and the printed circuit board is attached to the upper surface of the LED thermal pad, wherein the upper surface of the LED thermal pad includes at least one ridge-like structure that extends away from the upper surface and through at least one aperture in the printed circuit board, thereby allowing direct thermal and mechanical contact between the thermal pads of the at least one LED and the LED thermal pad. The LED thermal pad and the printed circuit board may each include apertures that allow passage of LED electrical connectors through the apertures to form an electrical connection with a set of LED contact pads. The LED thermal pad may include a plurality of heat transfer vias. The LED thermal pad may further comprise an electrically insulating layer and an electrically conductive contact pattern, where the electrically insulating layer is disposed on a portion of an upper surface of the thermal pad but is not interposed between the thermal pad of the at least one LED and the upper surface of the LED thermal pad, and where the electrically conductive contact pattern is disposed on the electrically insulating layer of material and couples a set of LED electrical contact pads to an LED drive circuit.

A further understanding of the nature and advantages of the present invention may be realized by reference to the remaining portions of the specification and the drawings.

### BRIEF DESCRIPTION OF THE DRAWINGS

FIG. 1 provides a side view of an LED light source fabricated in accordance with the invention;

FIG. 2 provides an exploded, perspective view of the three primary assemblies of the LED light source shown in FIG. 1;

FIG. 3 provides an exploded, perspective view of the base assembly shown in FIG. 2;

FIG. 4 provides a perspective view of an alternate base assembly utilizing a bayonet-style connector;

FIG. 5 provides an exploded, perspective view of the base member shown in FIG. 3;

FIG. 6 provides a cross-sectional view of a lower portion of the base member assembly of FIG. 3;

FIG. 7 provides a cross-sectional view that shows details of the base member/connector coupling;

FIG. 8 provides a perspective front view of the circuit board shown in FIG. 3;

FIG. 9 provides a perspective rear view of the circuit board shown in FIG. 8;

FIG. 10 provides further details for an LED light source compatible with a bayonet-style socket;

FIG. 11 provides a perspective front view of a circuit board configured for use with the base assembly shown in FIG. 10;

FIG. 12 illustrates an alternate base assembly;

FIG. 13 illustrates the primary elements of the preferred heat sink assembly;

FIG. 14 illustrates the back surface of an LED suitable for use with the invention;

FIG. 15 illustrates an alternate LED mounting configuration;

FIG. 16 illustrates an alternate cylindrical heat sink;

FIG. 17 illustrates yet another alternate cylindrical heat sink;

FIG. 18 provides an exploded, perspective view of the optical assembly shown in FIGS. 1 and 2;

FIG. 19 illustrates an alternate, dome-shaped optic for use with the optical assembly shown in FIGS. 1, 2 and 18;

FIG. 20 provides a cross-sectional view of an LED light source similar that shown in FIG. 1, except for the use of a dome-shaped optic;

FIG. 21 provides a detailed cross-sectional view of the attachment of the base of the optical assembly to the mounting arms;

FIG. 22 provides a detailed cross-sectional view of the mating surfaces of the upper and lower optical assembly members;

FIG. 23 provides an exploded, perspective view of a PAR-style optical assembly;

FIG. 24 provides a side view of an LED light source utilizing the optical assembly shown in FIG. 23 and a bayonet-style socket connector; and

FIG. 25 provides a cross-sectional view of the LED light source shown in FIG. 24.

### DESCRIPTION OF THE SPECIFIC EMBODIMENTS

In the following text, the terms “light source”, “light bulb”, “luminaire”, and “lamp” may be used interchangeably to refer to any of a variety of different light source configurations. The term LED refers to a light emitting diode. It should be understood that identical element symbols used on multiple figures refer to the same component, or components of equal functionality. Additionally, the accompanying figures are only meant to illustrate, not limit, the scope of the invention and should not be considered to be to scale.

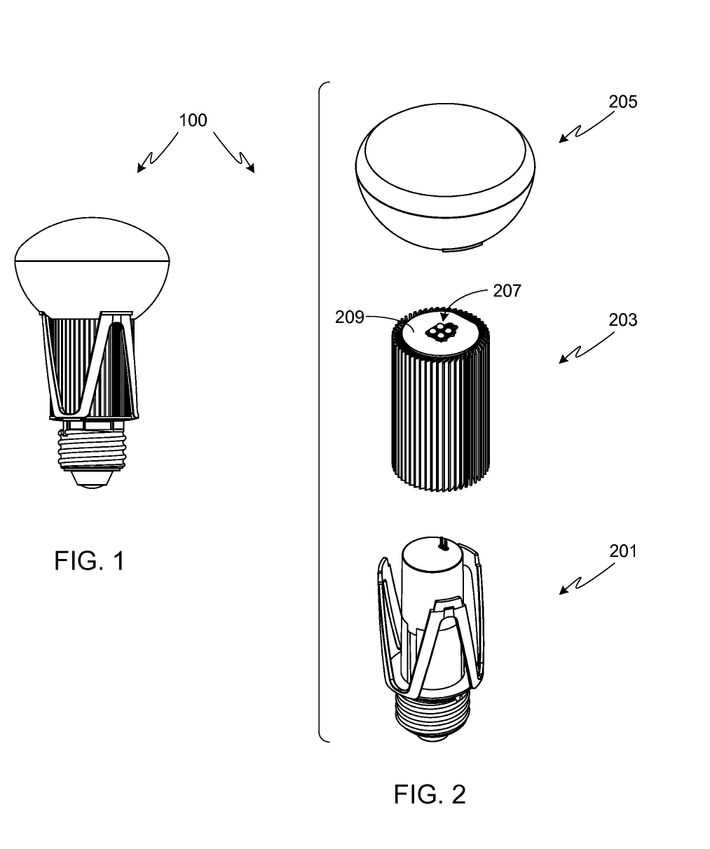

FIG. 1 provides a side view of an LED light source 100 fabricated in accordance with the invention. FIG. 2 provides an exploded, perspective view of LED light source 100 showing the three primary assemblies of LED light source 100. In particular, FIG. 2 shows base assembly 201, heat sink assembly 203 and the optical assembly 205. In this figure, four LEDs 207 are shown attached to the printed circuit board 209 of assembly 203.

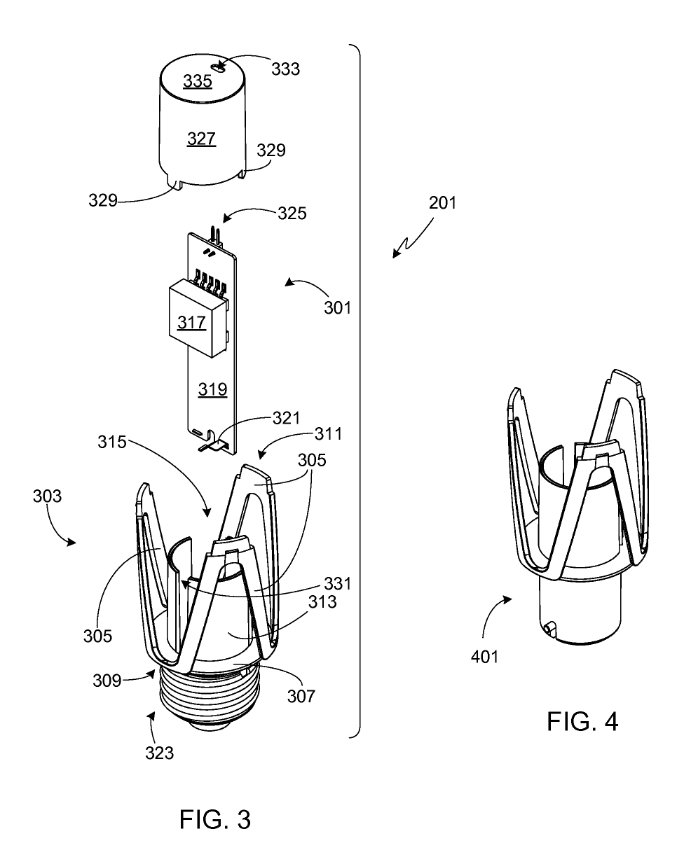

FIG. 3 provides an exploded, perspective view of base assembly 201. Base assembly 201 serves several purposes. First, it provides means for electrically connecting LED light source 100 to a suitable light socket. Second, assembly 201 provides a mounting location for LED light circuit 301. Third, assembly 201 provides a support base for both heat sink assembly 203 and optical assembly 205.

Base assembly 201 includes base support member 303. In the preferred embodiment, base support member 303 is comprised of a single, molded unit, although other fabrication techniques may be used during its manufacture. It is formed of an electrically insulating material that provides sufficient strength to not only provide a mounting base for the various elements of the light bulb, but also one that is capable of withstanding the forces applied when the bulb is screwed/unscrewed or otherwise coupled to a lighting receptacle. In the preferred embodiment, in addition to being electrically insulating, the selected material is capable of injection molding and is heat resistant and flame retardant. For example, any of a variety of plastics, polymers and thermoplastics may be used, although an FR grade polycarbonate thermoplastic polymer is preferred.

In the preferred embodiment, base support member 303 includes three optical assembly mounting arms 305. In the illustrated embodiment, mounting arms 305 are molded into member 303 thus simplifying construction of LED light 100 while achieving superior performance. As shown, arms 305 contact lower base region 307 at three locations 309 and provide three optical assembly mounting locations 311. By centering mount locations 311 between arm/base mounting locations 309 and by forming the arms in a continuous fashion as shown such that two arms meet and are joined together at locations 311, mounting arm strength is optimized, especially in terms of twisting motion such as that required during light bulb insertion and/or removal. It will be appreciated that while arms 305 provide the requisite strength and rigidity for mounting optical assembly 205, they enclose very little of the region surrounding central post 313. Preferably arms 305 enclose less than 60%, more preferably less than 70%, still more preferably less than 80%, and yet still more preferably less than 90% of the region surrounding post 313. Minimizing the enclosed region while still providing the required arm strength is important for heat dissipation, as described in detail below.

The center portion 315 of post 313 is hollow, thus providing a mounting location for LED light circuit 301. In general, LED light circuit 301 is used to rectify the alternating current supplied by the light socket into a suitable direct current for powering the light's LEDs. Preferably, LED light circuit 301 also includes the necessary circuitry to make LED light 100 compatible with a light dimming switch. Various manufacturers make suitable light circuits. For example, suitable TRIAC dimmable LED drive circuits are made by National Semiconductor®, STMicroelectronics®, NXP Semiconductors®, Infineon®, Texas Instruments® and others. The LED drive electronics (e.g., electronics 317) are mounted to a circuit board 319. Circuit board 319 also includes the contacts (e.g., contacts 321) that couple the board to the light connector (e.g., 323). Circuit board 319 also includes a connector 325 that is used to couple LED 207 to the lighting circuit. Preferably LED drive circuit 301 is positioned within the base assembly utilizing rib structures molded into base center post 313 and cap 327, and then held in place using a thermally conductive potting compound. Suitable potting compounds are made, for example, by Dow Corning® (e.g., Dow Corning® CN-8760). While the positioning slots created by the molded rib structures represent the preferred means of positioning drive circuit 301, it will be appreciated that other means may be used.

In the preferred embodiment, cap 327 fits over a portion of LED light circuit 301. One or more tabs 329 fit into corresponding slots 331, thus providing a simple means of aligning cap 327 to member 303. LED connectors 325 pass through an aperture 333 in cap end surface 335. Cap 327 may be held in place with an epoxy, with the potting compound used to hold LED light circuit 301 in place, or through an interference fit between tab or tabs 329 and corresponding slot(s) 331.

It should be appreciated that the present light source is not limited to a single socket connector. For example, while FIGS. 1-3 show the use of an E27 Edison screw connector 323, the same base assembly is shown in FIG. 4 utilizing a B22 bayonet style connector 401. Clearly the LED light source of the present invention is not limited to one of these two connector types. For example, the LED light source of the present invention may also be configured to utilize an E26 connector, an E14 connector, etc.

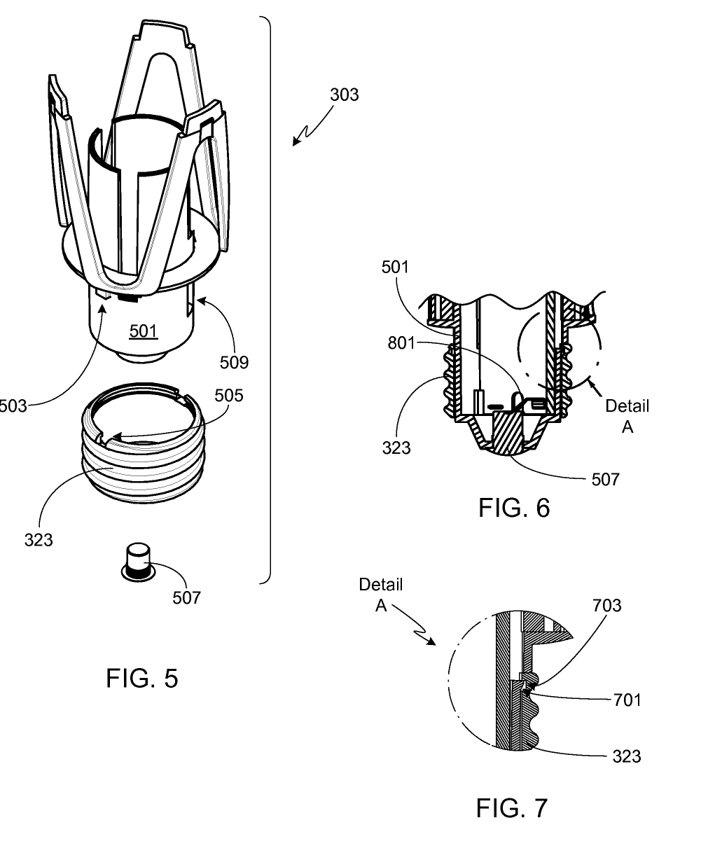

FIGS. 5-9 provide additional details regarding the fabrication and assembly of the preferred base member 303 shown in FIG. 3. As shown, an Edison screw-type connector 323 slides over portion 501 of base member 303. Connector 323 is fabricated from an electrically conductive material, preferably a metal such as aluminum, an aluminum alloy, etc. Molded into portion 501 of base member 303 is at least one, and preferably a pair of material extensions (e.g., rectangular positioning pins) 503 that are configured to fit within the corresponding slots 505 of connector 323, thereby preventing connector 323 from rotating about the base member when the light bulb is screwed into a light receptacle. Portion 501 of base member 303 also includes one or more teeth 701 that are configured to fit into connector groove 703, thereby locking the connector in place on the base assembly via a snap-fit. Inserted into a hole in the bottom of portion 501 is contact pin 507, pin 507 preferably held in place using an interference fit.

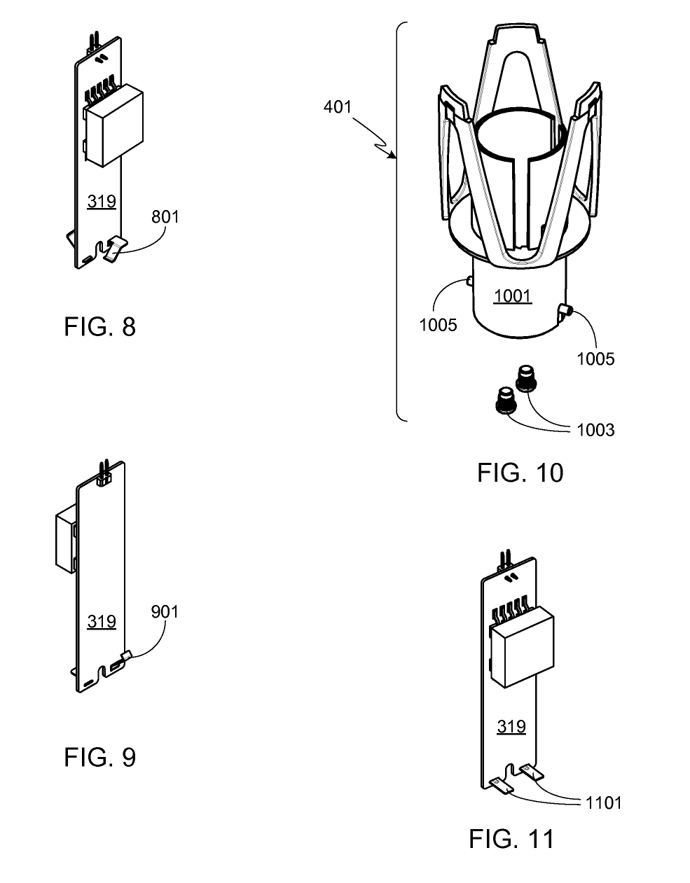

FIGS. 8 and 9 provide front and rear views, respectively, of circuit board 319. These views show the connectors that are suitable for the base assembly shown in FIGS. 3 and 5-7. In the illustrated embodiment, these connectors are formed using a spring steel or similar material. As a result, when LED light circuit 301 is in place in the base assembly, the connectors are placed in tension against the inner surfaces of the base assembly contacts. While the inventor has found that this approach provides a reliable electrical connection, other means of coupling the connectors to the contacts are envisioned, for example using solder, conductive epoxy, etc. In the specific illustrated embodiment, connector 801 is designed to press against and form an electrical connection with contact pin 507 as shown in FIG. 6. Connector 901 is designed to pass through slot 509 of base portion 501 and press against the inner surface of Edison base 323, thereby forming the necessary electrical connection.

FIG. 10 provides additional details regarding the base assembly shown in FIG. 4 that is designed for use with a bayonet style B22 socket. As shown in this figure, inserted into the bottom surface of base portion 1001 are contact pins 1003. Pins 1003, as with pin 507, are preferably pressed into place and held there using an interference fit. Other means (e.g., epoxy) may be used to hold these contact pins in place. In this configuration, and as shown in FIG. 11, circuit board 319 is provided with a pair of connectors 1101 located on the same side of the board, connectors 1101 designed to be placed into tension against pins 1003, thereby forming a reliable electrical connection. If desired, other means such as solder, conductive epoxy, etc. may be used to form the electrical contact between connectors 1101 and contact pins 1003. Note that in this embodiment, as with other bayonet style connectors, bayonet locking pins 1005 are press fit into the sides of base portion 1001, pins 1005 preferably being fabricated from metal.

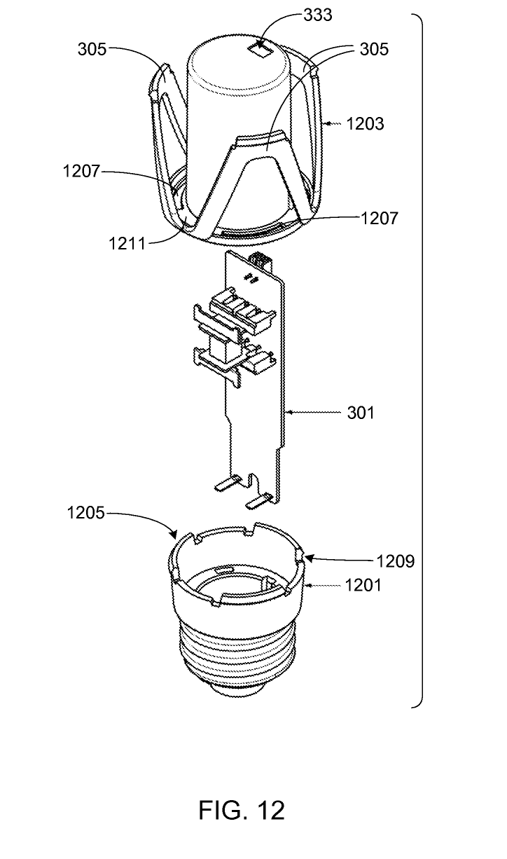

While the base assembly described above and shown in FIGS. 2-7 and 10 is preferred, clearly other configurations may be used that still provide the advantages of the present invention. For example, in FIG. 12 base member 303 is replaced with a lower base member 1201 and an upper base member 1203. Lower base member 1201 is designed to house the lower portion of lighting circuit 301. Preferably the connector (e.g., E27 or B22 connector) is attached to lower base member 1201 in the same manner as described above relative to member 303. Similarly, the circuit contacts (e.g., connectors 801, 901 and 1101) are preferably electrically coupled to the light sources contacts (e.g., contact pins 507 and 1003 and screw type connector 323) using the same approach as described and shown above.

In the embodiment illustrated in FIG. 12, upper member 1203 includes optical assembly mounting arms 305, center post 313, and cap 327, all fabricated as a single component. Lower member 1201 includes a plurality, typically three, of raised edges 1205 that are configured to slide through a set of corresponding slots 1207 fabricated into the bottom surface of upper member 1203. Each raised edge 1205 includes an extended rib (i.e., a lip) 1209. When edges 1205 are pressed through corresponding slots 1207, the extended ribs 1209 snap over surface 1211 of member 1203, thereby locking upper member 1203 to lower member 1201 via a snap-fit coupling. By utilizing multiple, discrete edges 1205, and corresponding slots 1207, rotation of upper member 1203 relative to lower member 1201 is prevented.

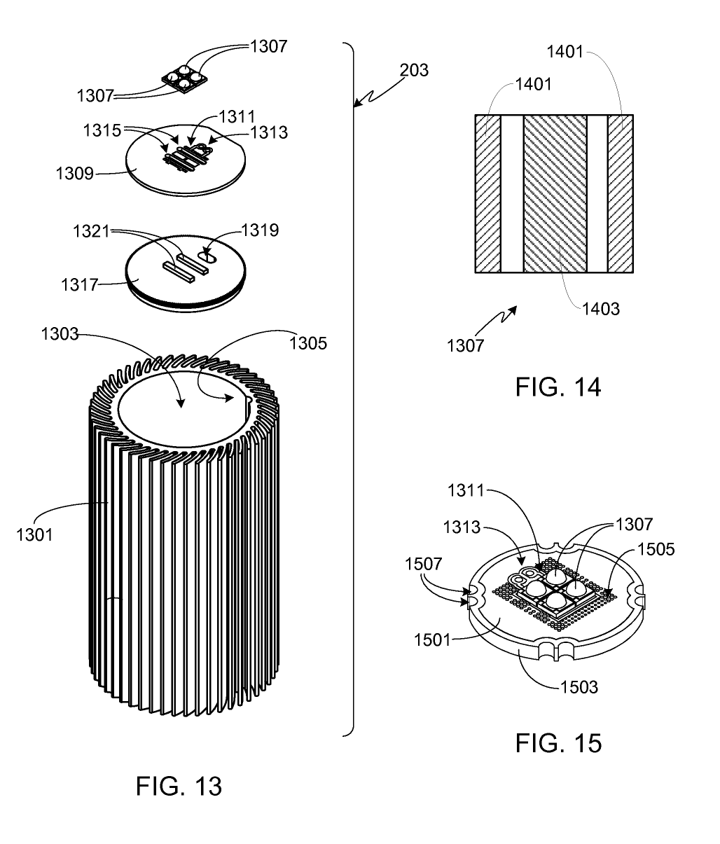

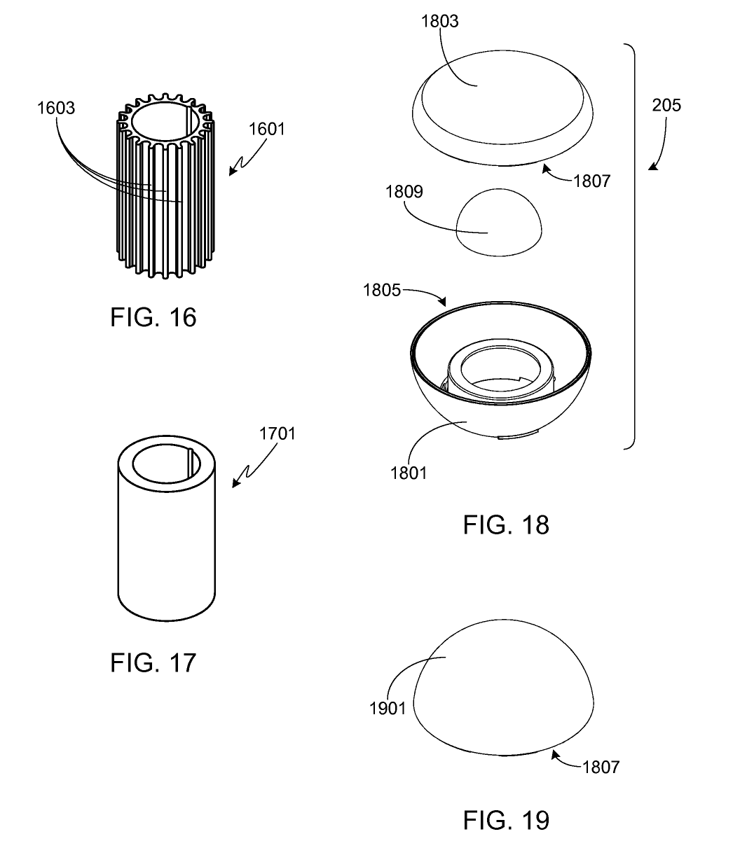

FIG. 13 illustrates the primary elements of the preferred heat sink assembly 203. Assembly 203 includes a cylindrical heat sink 1301. Heat sink 1301 includes a central bore 1303 that is configured to fit over center post 313 and cap 327 of base assembly 201. Preferably heat sink 1301 includes a groove 1305, visible in FIG. 13 as well as in FIGS. 16 and 17. Groove 1305 is designed to match-up with a ridge or other raised feature molded into the body of center post 313 or cap 327 or both, thereby preventing the rotation of heat sink 1301. Preventing heat sink rotation prevents stress being placed on LED connector 325. Heat sink 1301 is preferably fabricated from an aluminum extrusion, although it may be fabricated from any thermally conductive material, e.g., an aluminum alloy, brass, copper, steel, stainless steel, etc. Preferably heat sink 1301 is anodized, for example clear or black anodized, although other surface treatments may be applied (e.g., paint, powder coating, plating, etc.).

In the illustrated embodiment, four LEDs 1307 are attached to a printed circuit board (PCB) 1309. The present invention is equally applicable to LED light sources utilizing a fewer, or a greater, number of LEDs. PCB 1309 includes metal traces 1311 to which the cathode and anode contact pads for each LED 1307 are electrically connected, for example using a reflow soldering technique. During assembly, the contact pins from LED drive circuit connector 325 pass through holes 1313 in PCB 1309 and are soldered to the metal traces 1311. FIG. 14 shows the underside surface of a typical LED 1307, for example an XLamp XP-G or XM-L LED manufactured by Cree®. Cathode and anode LED contact pads 1401 are attached to metal traces 1311. PCB 1309 also includes slots 1315, slots 1315 passing completely through PCB 1309. Slots 1315 are configured to be aligned with the thermal pad 1403 located on the bottom of each LED 1307 as shown.

PCB 1309 is attached to the top surface of thermal pad 1317. In this embodiment, thermal pad 1317 is disc-shaped, thus allowing it to be press fit into central bore 1303 of heat sink 1301. Thermal pad 1317 is fabricated from a material with a high thermal conductivity such as copper. PCB 1309 may be riveted to pad 1317 or attached using other means (e.g., adhesive, clips, screws, etc.). Pad 1317 includes an aperture 1319 through which LED drive circuit connector 325 passes. Pad 1317 also includes raised features 1321, also referred to herein as a ridge-like structure, that are configured to fit through slots 1315 such that the top surfaces of features 1321 are in direct mechanical and thermal contact with thermal pads 1403 of LEDs 1307 when PCB 1309 is attached to disc 1317. Preferably pad 1317 and features 1321 are fabricated from a single piece of material, thus insuring a highly conductive path between the thermal pads of the LEDs and disc 1317. Note that thermal pads 1403 may be in direct contact with features 1321, or a layer of a thermal compound or thermal paste may be interposed between the two in order to enhance the transfer of heat from the LEDs to the heat sink.

Preferably thermal pad 1317 (also referred to herein as a thermal disc) is press fit into the bore 1303 of heat sink 1301. While the inventor has found that an interference fit between disc 1317 and heat sink 1301 is preferred, other means may be used to mount the disc within the end of the heat sink (e.g., solder, thermally conductive epoxy, etc.).

FIG. 15 illustrates a modification of the previous embodiment of the LED mounting system shown in FIG. 14. The LED mount shown in FIG. 15 directly combines the features and characteristics of PCB 1309 and thermal pad 1317. In this embodiment, an electrically insulating layer 1501 is deposited onto a thermally conductive pad 1503, pad 1503 being disc-shaped and fabricated from a material with a high thermal conductivity (e.g., copper). Contact pattern 1311 is applied, for example using screen printing techniques, to surface 1501. Surface 1501 preferably includes voids that allow LED thermal pads 1403 to be placed in direct contact to disc-shaped pad 1503. As in the prior embodiment, a thermal compound, paste, solder, etc. may be used to enhance heat transfer to the thermal pad from the LEDs. Pad 1503 may include various vias 1505 and cut-outs 1507 to enhance heat dissipation. As in the prior embodiment, preferably pad 1503 is press fit into bore 1303 of heat sink 1301 although other attachment techniques may be used.

The purpose of heat sink 1301 is to transfer heat away from the LEDs 1307 and drive circuit 301. As such, heat sink 1301 includes a plurality of curved fins, 50 in the preferred embodiment, which are designed to maximize surface area, and thus heat transfer away from the heat sink. Depending upon the expected heat load, other heat sink designs may be used. For example, if a greater thermal load is expected, the length of the fins may be increased. If a lower thermal load is expected, the fin design may be simplified. For example, FIGS. 16 and 17 illustrate alternate heat sinks 1601 and 1701, respectively. As shown, heat sinks 1601 and 1701 have the same dimensions as heat sink 1301, thus allowing them to be used in place of heat sink 1301 without modifying the LED thermal pad (e.g., pad 1317 or 1503). Heat sink 1601 includes a reduced number of fins 1603, the fins in this heat sink not being curved. Heat sink 1701 does not include any fins.

It will be appreciated that the LED light source of the present invention may be used with any of a variety of optical assemblies, thus allowing the disclosed light source to be used as a replacement for a range of incandescent and fluorescent lights. A few exemplary optical assemblies are described below and shown in the accompanying figures, although it should be understood that the invention is not limited to these configurations.

FIG. 18 provides an exploded, perspective view of the primary components comprising optical assembly 205. Specifically, assembly 205 includes a base 1801 and an optic 1803. Optic 1803 may also be referred to as a ‘mushroom-shaped dome’. The assembly is comprised of an upper and a lower portion both to simplify fabrication and to provide a simple means of varying configurations. For example, base 1801 may also be used with a dome-shaped optic 1901 as shown in FIG. 19.

The components comprising the optical assembly of the present invention may be fabricated from any of a variety of materials, and provided with any of a variety of surface treatments, depending upon the desired optical qualities as well as the intended cost and manufacturing process. Base 1801 and optic 1803, or optic 1901, are preferably fabricated from a plastic (e.g., polycarbonate, poly(methyl methacrylate) or PMMA, etc.). Note that they do not have to be made from the same material, or given the same surface treatment. In the preferred embodiment, clear polycarbonate or PMMA is used in which the internal surfaces have been textured to provide enhanced light diffusion and similar optical qualities to that of a frosted incandescent light bulb. Preferably edge 1805 of base 1801 and edge 1807 of optic 1803 (or optic 1901) are fabricated with interlocking ridges in order to simplify assembly. During assembly, base 1801 and the optic may be attached to one another utilizing any of a variety of epoxies and adhesives, etc.

Optical assembly 205 may include optional optical element 1809. Element 1809 may be used as a second light diffuser. Element 1809 may also be coated with a phosphor. Preferably element 1809, if included, is fabricated from clear polycarbonate, PMMA or other plastic.

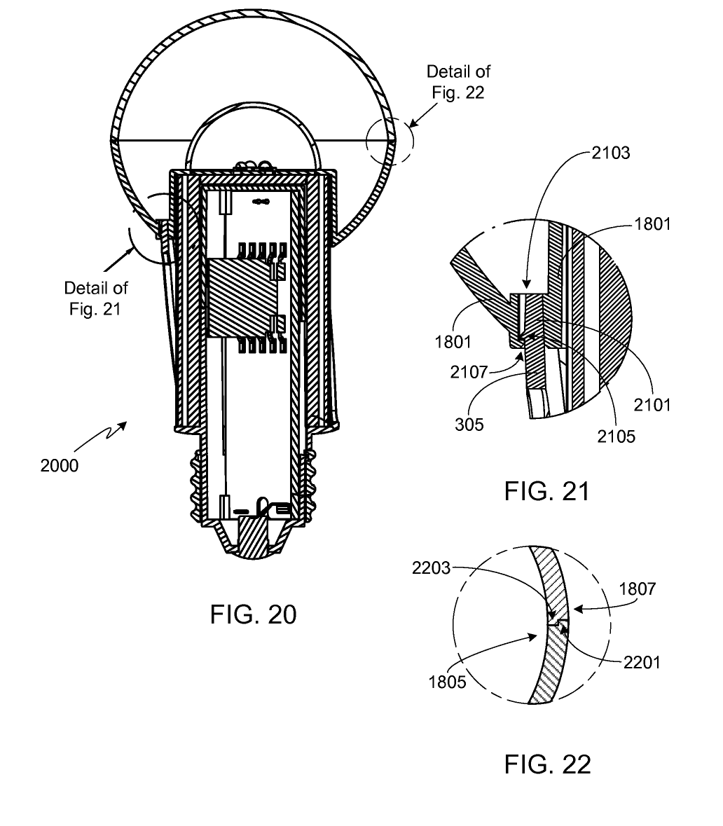

FIG. 20 provides a cross-sectional view of an LED light source similar to that shown in FIGS. 1 and 2, except the mushroom-shaped dome shown in FIGS. 1 and 2 has been replaced with a round dome 1901. As shown in the detailed cross-sectional view of FIG. 21, the end portion 2101 of each base assembly arm 305 fits within a corresponding slot 2103 formed in base 1801. End portion 2101 preferably includes a small ridge 2105 (also referred to as a lip) that is captured by edge 2107 of slot 2103 to form a snap-fit coupling. As a result of this design, the optical assembly is easily, and semi-permanently, attached to the base assembly of the LED light source. The detailed cross-sectional view of FIG. 22 shows the complementary ridge structures 2201 and 2203 molded or otherwise formed onto base edge 1805 and upper optic edge 1807, respectively.

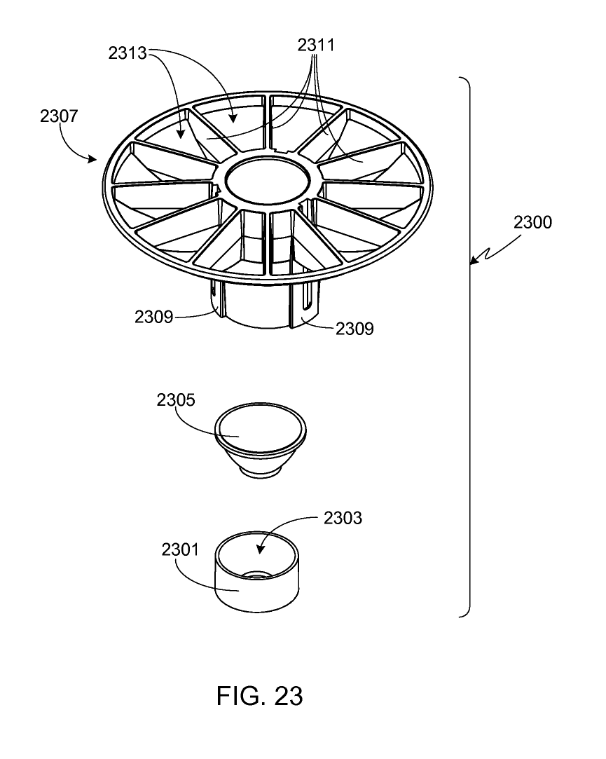

The LED light source of the present invention is not limited to A-style bulbs, e.g., A15, A17, A19, A21, etc. Rather, the present invention is equally applicable to other bulb styles (e.g., PAR-style, R-series, etc.). For example, the present invention is equally applicable to PAR20, PAR30 and PAR38 lights. FIGS. 23-25 illustrate an exemplary LED light source configured as a PAR-style light.

FIG. 23 provides an exploded, perspective view of the optical elements comprising the optical assembly 2300 of an LED light source configured as a PAR-style light, and yet designed to utilize the previously described base and heat sink assemblies. Lens support member 2301 fits on top of heat sink assembly 203 and includes an aperture 2303 that fits around LEDs 207. Preferably lens support member 2301 is fabricated from polycarbonate, although other materials, such as other types of plastic, may also be used. Sitting within lens support member 2301 is lens 2305. Lens 2305 is used to achieve the desired spot size, i.e., from a high angle spot light to a highly divergent flood light. Preferably lens 2305 is fabricated from PMMA, although other materials, such as other types of plastic, may also be used. Lens 2305 and lens support 2301 are held in place via frame 2307. Frame 2307 includes members 2309 that are designed to capture end portions 2101 of arms 305 in the same way as optical base member 1801. Frame 2307 may be fabricated from any of a variety of different materials, although preferably it is fabricated from either polycarbonate or PMMA. In the illustrated and preferred embodiment, frame 2307 utilizes a fin-like structure comprised of a plurality of ribs 2311 that are separated by voids 2313. This structure insures that air flow to heat sink assembly 203 is not limited, thus providing for the necessary levels of heat dissipation required by many LED light source configurations. It should be understood, however, that frame 2307 may be covered in whole, or in part, with a variety of materials to provide a different cosmetic appearance, assuming that voids 2313 are not deemed necessary for the particular configuration in question. In at least one embodiment, voids 2313 are covered with a porous material that gives the appearance of a solid upper light surface while still allowing sufficient air flow to the heat sink assembly.

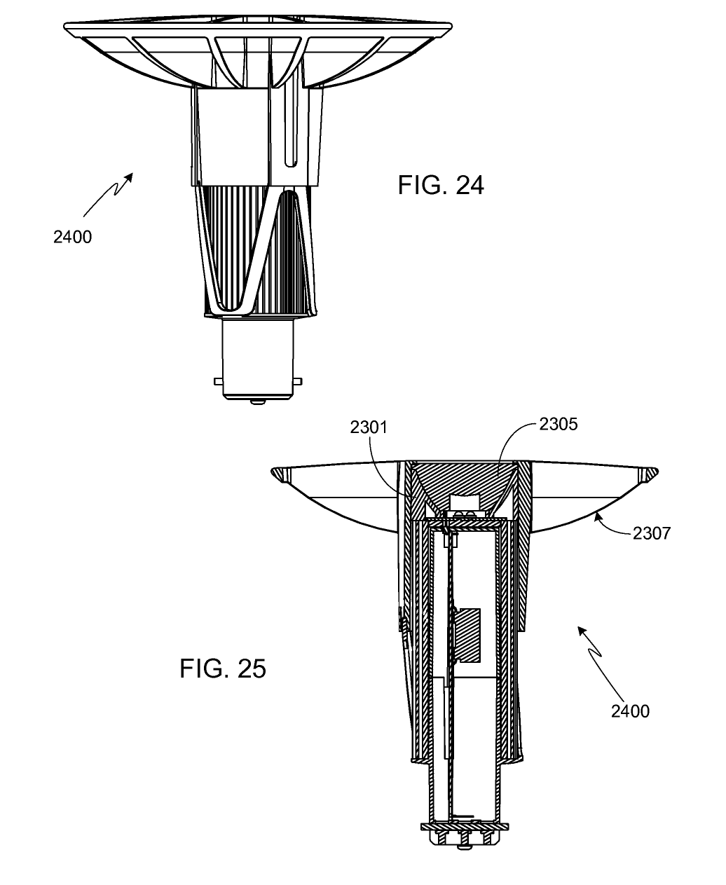

FIG. 24 provides a side view of an alternate embodiment of an LED light source 2400 fabricated in accordance with the invention. The illustrated embodiment utilizes the PAR-style optical assembly shown in FIG. 23. Additionally, this embodiment utilizes a bayonet-style socket connector rather than the Edison screw socket connector shown in FIG. 1. A cross-sectional view of this LED light source is shown in FIG. 25.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. An LED light source, comprising:
a heat sink assembly, comprising:
a cylindrical heat sink;
a disc-shaped LED thermal pad mechanically closing an end portion of said cylindrical heat sink, wherein said LED thermal pad is in direct mechanical and thermal contact with said heat sink; and
at least one LED, wherein a thermal pad of said at least one LED is in direct mechanical and thermal contact with an upper surface of said disc-shaped LED thermal pad.

2. The LED light source of claim 1, further comprising a printed circuit board, wherein said at least one LED is attached to said printed circuit board and said printed circuit board is attached to said upper surface of said disc-shaped LED thermal pad, wherein said printed circuit board further comprises at least one aperture, wherein said upper surface of said disc-shaped LED thermal pad further comprises at least one ridge-like structure extending away from said upper surface, wherein said at least one ridge-like structure passes through said at least one aperture in said printed circuit board to form said direct mechanical and thermal contact between said disc-shaped LED thermal pad and said thermal pad of said at least one LED.

3. The LED light source of claim 2, wherein said disc-shaped LED thermal pad and said at least one ridge-like structure is fabricated from a single piece of thermally conductive material to form a single assembly.

4. The LED light source of claim 2, wherein said cylindrical heat sink includes a cylindrical outer surface, and wherein said cylindrical outer surface includes a plurality of fins.

5. The LED light source of claim 2, wherein said disc-shaped LED thermal pad includes at least one aperture, wherein said printed circuit board includes at least one connector aperture, and wherein at least one LED electrical connector passes through said at least one aperture of said disc-shaped LED thermal pad and through said at least one connector aperture of said printed circuit board to form an electrical connection with a set of LED electrical contact pads.

6. The LED light source of claim 2, wherein said disc-shaped LED thermal pad includes a plurality of vias, said plurality of vias allowing heat transfer from within said cylindrical heat sink to outside said cylindrical heat sink.

7. The LED light source of claim 1, further comprising an electrically insulating layer of material disposed on a portion of said upper surface of said disc-shaped LED thermal pad, wherein said electrically insulating layer of material is not interposed between said thermal pad of said at least one LED and said upper surface of said disc-shaped LED thermal pad, wherein said LED light source further comprises an electrically conductive contact pattern disposed on said electrically insulating layer of material, wherein said electrically conductive contact pattern electrically couples a set of LED electrical contact pads to an LED drive circuit.

8. The LED light source of claim 1, wherein said disc-shaped LED thermal pad forms an interference fit with an inner surface of said cylindrical heat sink.

9. An LED light source, comprising:
a heat sink assembly, comprising:
a hollow heat sink, said hollow heat sink comprising an opening;
an LED thermal pad shaped to mechanically close said opening of said heat sink, wherein said LED thermal pad is in direct mechanical and thermal contact with said heat sink; and
at least one LED, wherein a thermal pad of said at least one LED is in direct mechanical and thermal contact with an upper surface of said LED thermal pad.

10. The LED light source of claim 9, wherein an outer surface of said hollow heat sink is covered by a plurality of fins.

11. The LED light source of claim 9, wherein said LED thermal pad forms an interference fit with said opening of said hollow heat sink.

12. The LED light source of claim 9, further comprising a printed circuit board, wherein said at least one LED is attached to said printed circuit board and said printed circuit board is attached to an upper surface of said LED thermal pad, wherein said printed circuit board further comprises at least one aperture, wherein said upper surface of said LED thermal pad further comprises at least one ridge-like structure extending away from said upper surface, wherein said at least one ridge-like structure passes through said at least one aperture in said printed circuit board to form said direct mechanical and thermal contact between said LED thermal pad and said thermal pad of said at least one LED.

13. The LED light source of claim 12, wherein said LED thermal pad and said at least one ridge-like structure is fabricated from a single piece of thermally conductive material to form a single assembly.

14. The LED light source of claim 12, wherein said LED thermal pad includes at least one aperture, wherein said printed circuit board includes at least one connector aperture, and wherein at least one LED electrical connector passes through said at least one aperture of said LED thermal pad and through said at least one connector aperture of said printed circuit board to form an electrical connection with a set of LED electrical contact pads.

15. The LED light source of claim 12, wherein said LED thermal pad includes a plurality of vias, said plurality of vias allowing heat transfer from within said hollow heat sink to outside said hollow heat sink.

16. The LED light source of claim 9, further comprising an electrically insulating layer of material disposed on a portion of said upper surface of said disc-shaped LED thermal pad, wherein said electrically insulating layer of material is not interposed between said thermal pad of said at least one LED and said upper surface of said LED thermal pad, wherein said LED light source further comprises an electrically conductive contact pattern disposed on said electrically insulating layer of material, wherein said electrically conductive contact pattern electrically couples a set of LED electrical contact pads to an LED drive circuit.
